(19) United States
(12) Patent Application Publication
(10) Pub. No.: US 2009/0210697 A1
(43) Pub. Date: Aug. 20, 2009

(54) Digital Rights Protection in BitTorrent-like P2P Systems

(76) Inventors: Songqing Chen, Fairfax, VA (US); Xinwen Zhang, San Jose, CA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/354,798

(22) Filed: Jan. 16, 2009

Related U.S. Application Data
(60) Provisional application No. 61/021,668, filed on Jan. 17, 2008.

(51) Int. Cl. H04L 9/00

(52) U.S. Cl. 713/153; 380/277

(57) ABSTRACT

To leverage the efficiency and the scalability of BitTorrent (BT) systems for Internet content distribution, the present invention discloses enhancing BT peer-to-peer systems to enable digital rights management without infrastructure changes. The technique involves runtime re-encryption of each file piece, which may already be encrypted, before a peer uploads it to any other peer. To access the re-encrypted pieces, a tracker site generates decryption keys that are unique for each peer and for each file piece. While any user can take part in the content distribution, only legitimate users with the unique decryption keys can access the plaintext of the encrypted distributed content.

### CROSS REFERENCE TO RELATED APPLICATIONS

The present application claims the benefit of provisional patent application Ser. No. 61/021,668 to Chen et al., filed on Jan. 17, 2008, entitled “Towards Digital Rights Protection in BitTorrent-like P2P Systems,” which is hereby incorporated by reference.

### STATEMENT REGARDING FEDERALLY SPONSORED RESEARCH OR DEVELOPMENT

This invention was made with government support under grant numbers CNS-0509061 and CNS-0621631 awarded by the National Science Foundation. The government has certain rights in the invention.

### BACKGROUND OF THE INVENTION

BitTorrent-like (BT) systems have attracted considerable attention due to their scalability and efficiency for content distribution. As reported in June 2004, P2P traffic has made up 80% traffic on the Internet—53% of which is BT traffic. Much of the content distributed through BT systems has evolved from relatively small MP3 files to large files. Recently, some open source projects use BT systems to distribute newly released software packages.

As an efficient content distribution vehicle, BT systems distribute files in small file pieces (e.g., 256 KB per piece) with the assistance of a tracker site. In general, a BT system works as follows. Before an object is distributed, a meta file (normally called “.torrent”) is produced. The meta-file includes the object information (e.g., file name, length, etc.), a string of hash values of all file pieces based on SHA1, and the URL of a tracker site. When a client (also called “peer”) wants to download the file, it first gets the meta file (e.g., from a public server) and then queries the tracker site. The tracker site always maintains the information of peers who are active (downloading and/or uploading) in the torrent. Upon a client request, the tracker site responds with a list of active peers on which file pieces are available. The client then starts to download different file pieces from these active peers in parallel. After a piece is downloaded, its hash is calculated and compared with that in the .torrent file to verify its integrity. Each downloading peer also reports to the tracker site periodically (typically ˜30 minutes) so that the tracker site can provide updated active peer information to other peers upon a peer request. In a BT system, normally a peer that is downloading is also uploading to other peers, and a peer often simultaneously uploads available pieces to a limited number (for example, 5) of peers at a time. Peers are encouraged to upload using the tit-for-tat incentive scheme. Once a peer finishes downloading, it becomes a seed in the torrent. A seed is a peer that has all file pieces in a torrent, and only uploads to others. In a torrent, there is at least one seed that has the entire file at the beginning.

Many studies through modeling and measurements have shown that BT systems are scalable and efficient. However, existing BT systems have not been used to distribute the majority of legal digital objects. As most files currently shared in BT systems are non-copyrighted or pirated, there are a number of lawsuits concerning the copyright infringement. Hence, a copyright protection mechanism is desperately demanded before BT systems can be widely leveraged for distributing copyrighted Internet content.

The currently popular mechanism for copyright protection over the Internet is Digital Rights Management (DRM). With DRM, typically an object is encrypted by a server before distribution. A client downloads an encrypted copy, which is encoded with a unique serial number (ID) or encrypted with a unique key by the server. A license is needed to play or view the content, which includes the decryption key and the usage policy (e.g., a user can only play an obtained movie for 5 times), according to other information, such as the user's payment.

There are different models to integrate the license management and the enforcement mechanism in DRM. For example, with Microsoft's DRM technology, each media file is encrypted with a unique key. The media player on the client side must contact a license server and obtain a license file that includes the key ID and the key seed to recover the unique decryption key before playing. The media player enforces the usage policy defined in the license file, and decrypts the content with the decryption key while playing.

In Apple's iTunes and QuickTime that use the FairPlay DRM technology, a music file is encrypted with a master key, which, in turn, is encrypted with a unique user key and encoded in the file. Before playing the music, the client side player must obtain the user key from the server, decrypt the master key and enforce the usage policy.

Thus, to enforce DRM, each user should obtain a unique copy of an object, either encoded with a unique ID or encrypted with a unique key. This is fairly easy to implement in a client-server model that is mainly adopted in current practice. However, in a BT system, encrypting an object before distribution does not work since peers download exactly same pieces from each other (instead of from a single source) and all clients get the same object. Therefore, the decryption key in the license file is the same for all clients. Such a system is not immune to compromised users. In other words, a single compromised license file can break the security of the whole system.

Alternatively, it is also difficult to assign unique IDs or attach other meta information to objects downloaded by different peers in a BT system, which are mandatory in most existing DRM applications. For example, after downloading a copyrighted software, a user needs to obtain a license to install and run the software, which uniquely identifies the downloaded object. Unfortunately, existing BT systems cannot support this since a unique license cannot be defined. Therefore, DRM technologies cannot be applied through this approach.

A direct application of DRM for BT systems could work if the following requirements can be satisfied. Each file piece is headed with a unique serial number for a peer. When this peer (uploader) uploads this piece to another peer (downloader), the head information of the downloader is provided by the tracker site and updated by the uploader. However, this requires the trusted behavior of each peer, and assumes that BT client software can recognize and update the head information. Such requirements are not realistic because a general peer cannot be trusted to behave in an expected manner. Thus, the unique challenge to enforce DRM in BT systems lies in the conflict between security requirements and the open environment where a peer downloads different pieces from various sources. To leverage the capability of BT systems for efficient Internet content distribution, what is needed is a novel scheme to enable DRM without additional infrastructure changes to existing BT systems.

### BRIEF DESCRIPTION OF THE DRAWINGS

FIG. 1 shows an exemplified flow diagram of one re-encryption embodiment that can be implemented in BT peer-to-peer systems.

FIG. 2 shows another exemplified flow diagram of another re-encryption embodiment that can be implemented in BT peer-to-peer systems.

FIG. 3 shows an example of a flow diagram of a BT peer-to-peer system.

FIG. 4 shows an extended example of a flow diagram of BT peer-to-peer system.

FIG. 5 shows an exemplified flow diagram that implements a re-encryption embodiment to enhance BT peer-to-peer systems.

FIG. 6 shows an exemplified block diagram of an aspect of a digital rights protection system.

FIG. 7 shows another exemplified block diagram of the digital rights protection system.

FIG. 8 shows an example of a secure BT system architecture between two peers.

FIG. 9 shows an example of a tracker's response time with different file piece sizes.

FIG. 10 shows an example of system throughput with different sizes of file pieces.

### DETAILED DESCRIPTION OF THE INVENTION

The present invention relates to enhancing BT systems without additional changes to BT systems and enabling DRM. In one embodiment, the content distributed via BT systems is encrypted, and different decryption keys are used for different clients and different files and/or pieces of files. DRM would rely on different keys to identify different copies (e.g., each copy having a unique, different key). In particular, re-encryption is performed while a peer uploads a file piece to any other peer. Any user can involve a torrent to speed up the content distribution, but only legitimate users can access the plaintext of the content, since only legitimate users can get the unique decryption key for each file piece.

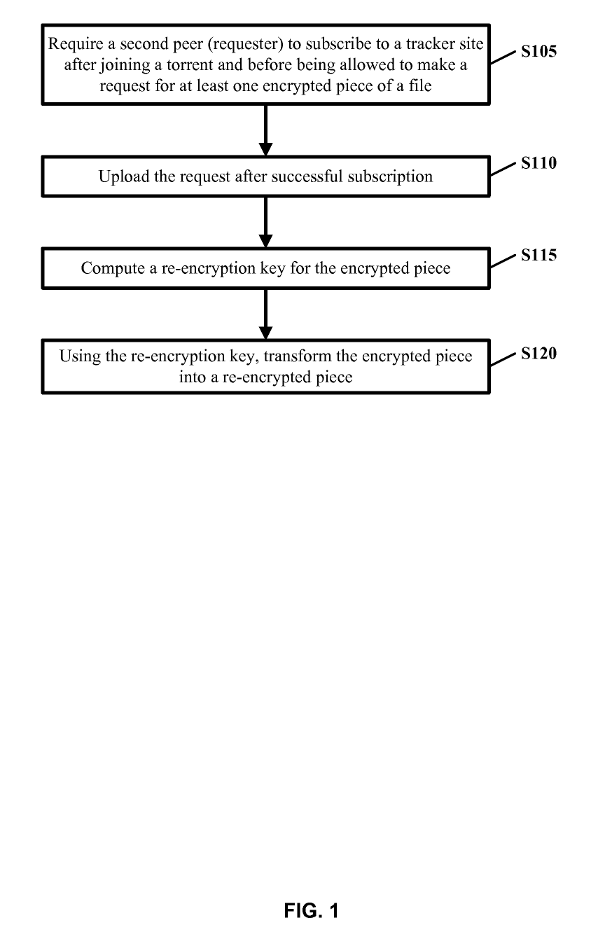

To resolve the problems presented by current BT systems, the present invention teaches securing BT systems by re-encrypting encrypted pieces of a file prior to peer-to-peer transfers. Overall, referring to FIG. 1, before a second peer (requester) is allowed to make a request for at least one encrypted piece of a file, the second peer is required to subscribe to a tracker site after joining a torrent S105. After successful subscription, then the request may be uploaded to the tracker site S110. Once the request is uploaded, the tracker site may compute a re-encryption key for the encrypted piece S115. The re-encryption key, as explained further below, is generally a polynomial quotient of a public key of a second peer divided by a public key of a first peer (holder). In this example, the second peer represents the requester of the encrypted piece and the first peer represents the holder of the encrypted piece/re-encrypted piece. Using the re-encryption key, the encrypted piece may be transformed into a re-encrypted piece S120.

It should be noted that when a peer successfully subscribes to a tracker site, a public key and a private key may be generated. The public key may be forwarded to the tracker site for registration and be used later to create a re-encryption key. This action allows the tracker site to determine who is legally allowed (e.g., having paid for a subscription) to download a file(s) or pieces of a file, whether encrypted or not, from another peer. A verification process may take place to determine a peer's eligibility to download and/or decrypt file(s) or pieces of a file. These file(s) and/or pieces of a file may be any kind of content (e.g., movies, TV shows, music, podcasts, blogs, pictures, etc.) that can be viewed or played on a viewer, such as QuickTime, Windows Media Player, RealPlayer, etc. Meanwhile, the private key may be used to decrypt an encrypted file that has not yet been re-encrypted.

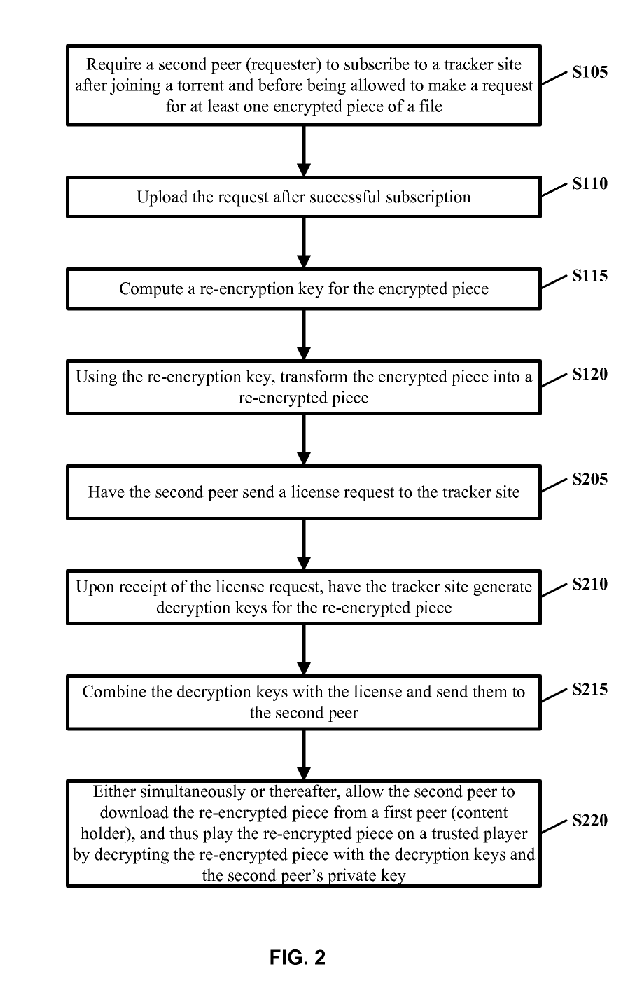

To receive the re-encrypted piece, the second peer (the requester) must send a license request to the tracker site S205, as shown in FIG. 2. The verification process may take place at this stage. Upon receipt of the license request, the tracker site may generate decryption keys for the re-encrypted piece S210. These decryption keys may be combined with the license and be sent to the second peer S215. Either simultaneously or thereafter, the second peer may download the re-encrypted piece from the first peer, and thus play the re-encrypted piece on a trusted player by decrypting the re-encrypted piece with the decryption keys and the second peer's private key S220.

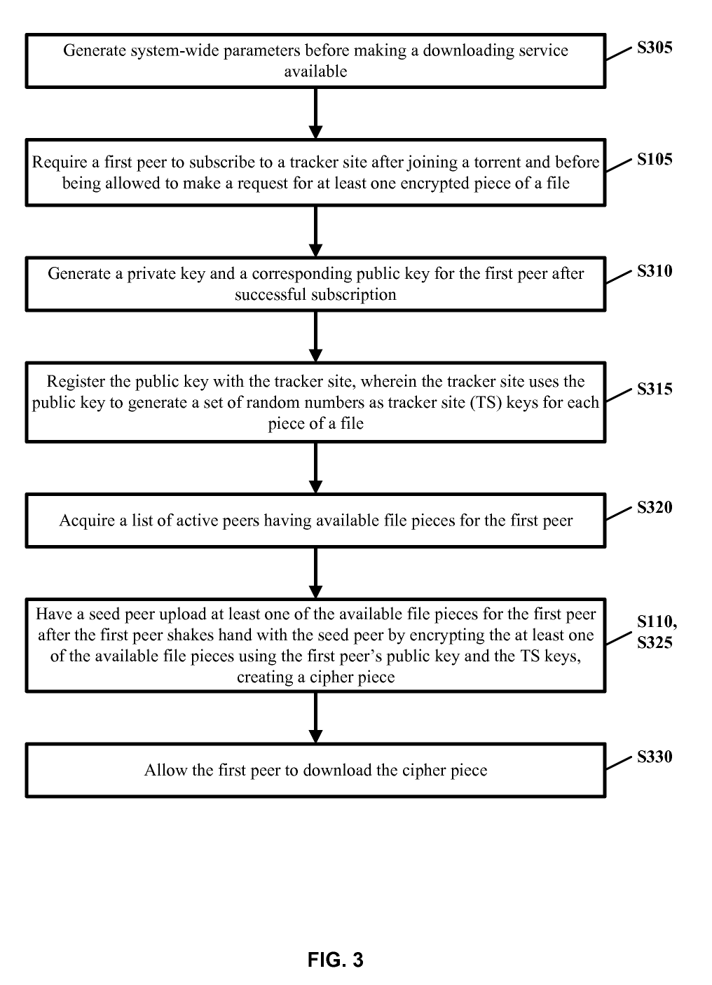

FIG. 3 shows an embodiment of how a BT system may operate. As depicted, system-wide parameters may be generated prior to making any downloading service available S305. A peer, say first peer in this example, seeking a particular file or part of a file in a BT peer-to-peer system needs to join a torrent. After joining, the peer may be required to subscribe to a tracker site before being able to make a request for a file or a piece of a file S105. After successfully subscribing, a private key and a corresponding public key may be generated for the peer S310. While the peers holds on to the private key, the public key may be forwarded to the tracker site for registration, S315. Once the tracker site receives the public key, the tracker site may use the public key to generate a set of random numbers as tracker site (TS) keys for each piece of a file. The subscribed peer may then acquire a list of active peers to see who has available file pieces for downloading S320. These available file pieces may be held by a seed peer. When the peer makes a request for the available file piece(s) and “shakes hand” with the seed peer, the seed peer may upload the available file piece(s) by encrypting the available file piece(s) with the peer's public key and the TS keys S110, S325. “Shakes hand” is a point in time and/or thereafter when one or more different peers (who have at least one available file piece being sought) agree to exchange the available file piece(s) with another peer(s) seeking such file piece(s). The result of this encryption may be a cipher piece. Once the cipher piece is created, the peer may download it S330.

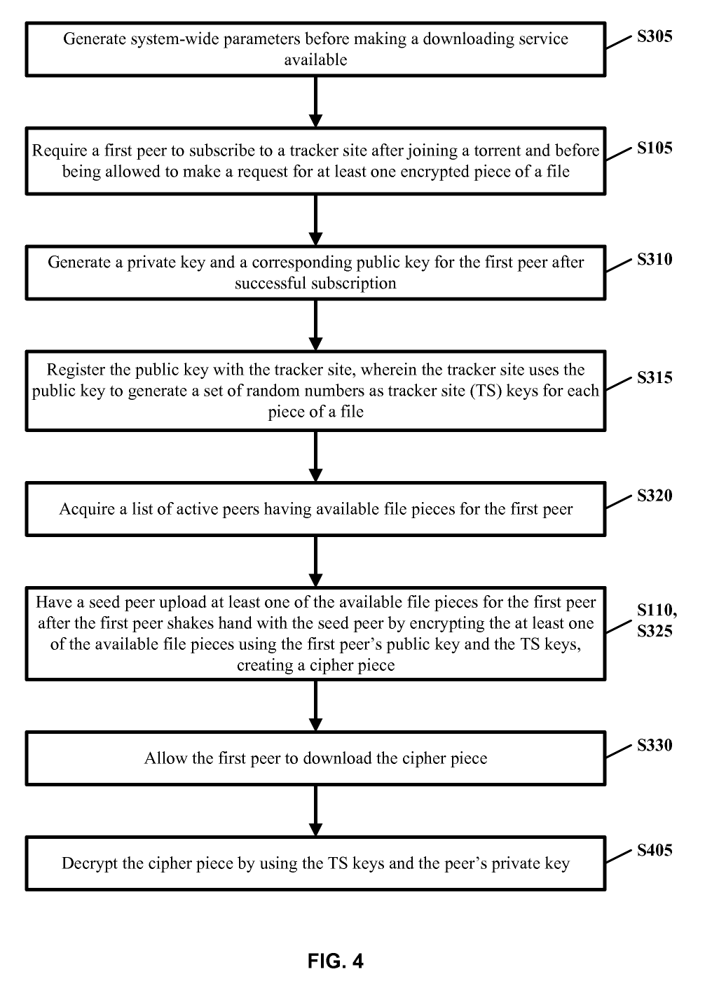

However, it should be noted that once the peer downloads the cipher piece, the cipher piece is still encrypted. For the peer to play the cipher piece on a trusted player, the peer must decrypt the cipher piece S405, as indicated in FIG. 4. Thus, as another embodiment, the downloaded cipher piece may be decrypted by using the TS keys and the peer's private key.

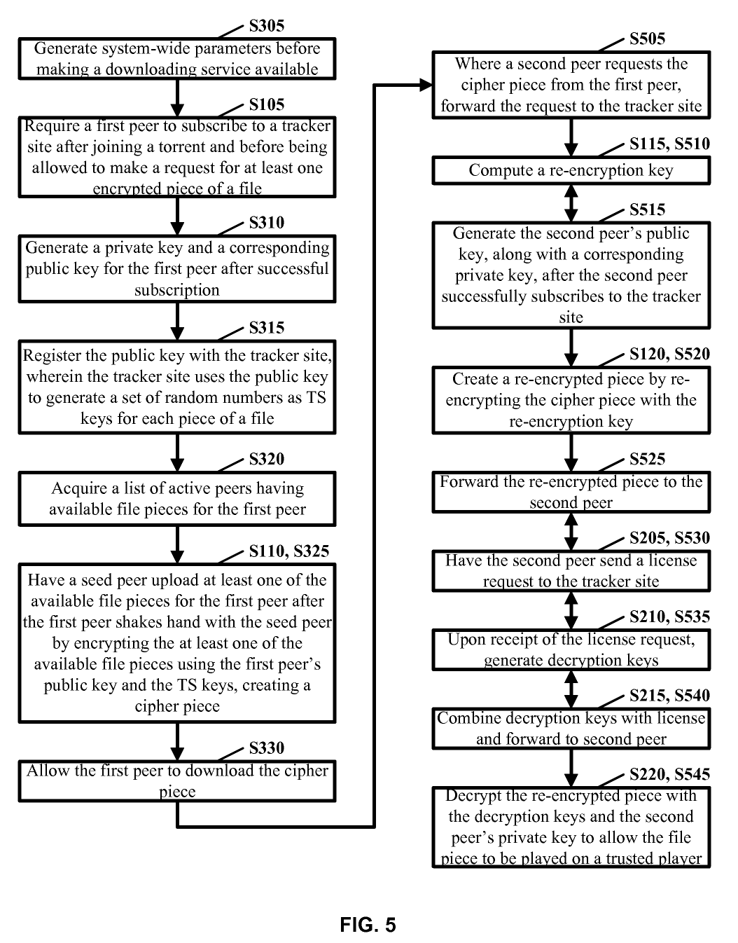

FIG. 5 shows an embodiment of how this overall re-encryption scheme may be implemented for enhancing any BT system and securing protection of digital rights in content. If another peer, say a second peer, requests the cipher piece from the first peer, the first peer would forward the request to the tracker site S505. Upon receipt, the tracker site may compute a re-encryption key S115, S510. The re-encryption key is the mathematical division (e.g., a/b, based on the crypto system used) between a public key of the second peer and the first peer's public key. The re-encryption key may be used to re-encrypt the cipher piece S120, S520. As a result, a re-encrypted piece may be created. This re-encrypted piece may be forwarded to the second peer S525.

It should be noted that there are instances where this re-encrypted piece will not be forwarded. For example, if the second peer decides to cancel subscription after the request is made, the re-encrypted piece may not be forwarded to the second peer.

As another note, similar to how the first peer's public key and private key were generated, the second peer's public key may can be generated, along with a corresponding private key, after the second peer successfully subscribes to the tracker site S515.

Because the re-encrypted piece needs to be decrypted before it can be played on a trusted content, the second peer needs to send a valid license request to the tracker site S205, S530. Upon receipt of the license request, the tracker site then generates the decryption keys S210, S535. Once generated, the tracker site may combine them in the license and forward both to the second peer S215, S540. Using the decryption keys and the second peer's private key, the second peer may decrypt the re-encrypted piece, allowing the file piece(s) to be played on a trusted player or site S220, S545.

It should be noted that as another embodiment, the present invention includes a validation process to verify that the forwarded license request is authenticated and/or authorized. If the license request cannot be verified, the tracker site is prevented from creating any decryption key for the re-encrypted piece, whether or not the second peer has already received the re-encrypted piece. Furthermore, an invalid license request may trigger a prohibition action within the tracker site to prevent any decryption key created for the re-encrypted piece to be sent. In other words, the tracker site may be prevented from forwarding the decryption keys for the re-encrypted piece. Without the decryption keys, it is expected that the content cannot be played on a trusted viewer, player or site.

As a further embodiment, the present invention can work on any player, trusted player or site. Nonlimiting examples include Windows Media Player, QuickTime, Real Player, etc.

As yet a further embodiment, any computer program (e.g., C, Java, etc.) may be used to create this program.

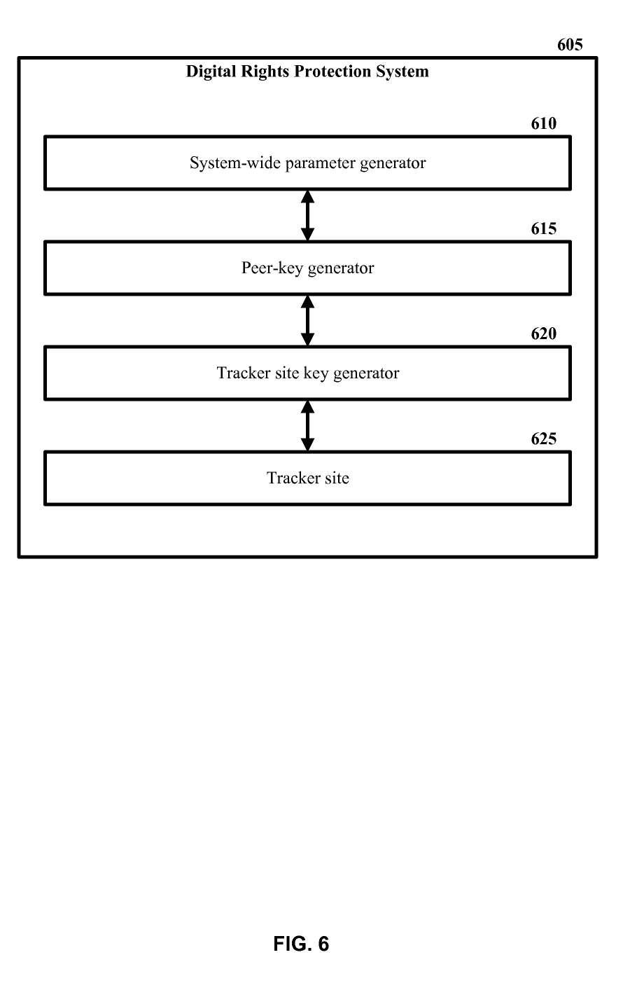

This kind of process may be implemented in a digital rights protection system with an architecture 605, as depicted in FIG. 6, that can enhance BT peer-to-peer systems. Nonlimiting components within such system may include a system-wide parameter generator 610, a peer-key generator 615, a tracker site key generator 620, and a tracker site 625.

The system-wide parameter generator 610 may be configured for generating at least two system-wide parameters.

The peer-key generator 615 may be configured, for each peer, a random number as a private key and a corresponding public key for the private key, when the peer subscribes to a tracker site.

The tracker site key generator 620 may be configured for using the public key to generate a set of random numbers as TS keys for each piece of a file. The random numbers may equal the number of file piece(s).

The tracker site 625 may be configured for creating a cipher piece, generating at least one re-encryption key, and generating decryption keys upon receipt of a license request.

To create the cipher piece, the public key and the TS keys may be used. The public key may be registered with the tracker site. To re-encrypt the cipher piece, the re-encryption key may be used.

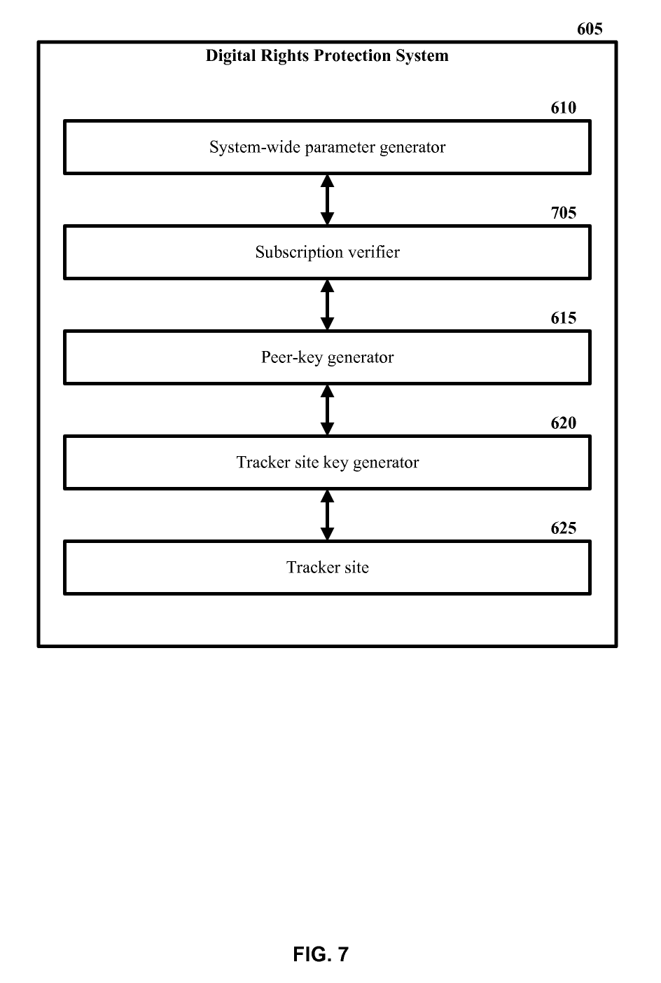

As yet another embodiment, the digital rights protection system 605 may also include a subscription verifier 705, as shown in FIG. 7. The subscription verifier 705 may be configured for verifying successful subscription to the tracker site. If verification is made, the subscription verifier 705 may then forward a signal to the peer-key generator 615 to commence generation of the private key and the corresponding public key.

In enhancing BT systems, the following assumptions are made, which define the trust boundary of the present invention.

Similar to the current DRM practice, for digital media content (e.g., video and audio media), it is assumed that on the client side, a player (or a plug-in of a player) is responsible for decrypting and enforcing the usage policy of an object without releasing the decryption key and plaintext of object pieces. The keys and policies are protected in a license file. For any other type of content, it is assumed that there exists a content viewer with similar functions on the client side. It should be noted that the present invention does not consider content leakage on the client side by jacking the player or the viewer.

It is further assumed that the original seed and the tracker site of a torrent are trusted by the object owner. That is, the original seed will not upload plain pieces of the object to any peer. It is either the object owner or trusted by the object owner. Similarly, for the tracker site, it is assumed that it is either maintained by the owner, or there is a trustworthy relationship between them.

With the trusted original seed and the tracker site, the content distributed via BT systems is encrypted from the beginning. Different decryption keys are used for different clients and different file pieces. While a peer needs to upload encrypted file pieces to other peers, the encrypted file pieces are re-encrypted so that only the designated users can decrypt the file.

I. Principle of Secure BT System

The leveraged security algorithm is based on the discrete logarithm problem and is similar to El Gamal public system. The following briefly reviews the El Gamal first, and then the formal definition of the secure BT system (the present invention) is presented.

A. Definition of El Gamal Cryptosystem: Let ε_{eg}=(Gen, Enc, Dec) be the standard El Gamal public-key encryption scheme. Gen outputs system parameters g and p, a random number a (used as the private key), and the public key g^{a} mod p. Enc is the encryption algorithm with input of message m and outputs (mg^{ar} mod p, g^{r} mod p) as the cipher message, where r is a random number. Dec is the decryption algorithm with the private key by dividing mg^{ar} mod p with (g^{r})^{a} mod p to retrieve the plain message m.

El Gamal is known to be chosen-plaintext attack secure. Based on the proven security of El Gamal scheme, the enhanced scheme (the present invention) is defined as follows (assuming all arithmetic to be mod p unless indicated explicitly).

B. Definition of Secure BT System (present invention): Secure BT System is an asymmetric system comprising a sextuple ε_{bt}=(SGen, PGen, TGen, PEnc, PDec, T), each of which is a polynomially computable algorithm as follows.

1. SGen(1ⁿ) is an algorithm generating system-wide parameters g and p, where p is an n-bit large random prime, g is a generator of the multiplicative group Z*ₚ of the integers modulo p.

2. PGen(Pⱼ) is a key generation algorithm for a peer (Pⱼ) resulting in a random number sⱼ as its private key, where 1≦sⱼ≦p−2, and the corresponding public key g^{s}^{ⱼ}.

3. TGen(Pⱼ) is a key generation algorithm running on the tracker site. After a peer Pⱼ subscribes, the tracker site uses TGen to generate a set of distinct random numbers r_{1, j}, . . . , r_{N,j} as the tracker site (abbreviated as TS hereinafter) keys of Pⱼ, where N is the number of pieces of a file. These are used by the tracker site to derive re-encryption keys and by Pⱼ to decrypt cipher pieces.

4. PEnc(Pⱼ, mᵢ) is performed by the original seed to encrypt piece mᵢ, with the public key of a downloader (Pⱼ) and the corresponding TS key, i.e., PEnc(Pⱼ, mᵢ) outputs mᵢ(g^{s}^{ⱼ})^{r}^{_{i,j}}=mᵢg^{r}^{_{i,j}}^{s}^{ⱼ}.

5. PDec(Pⱼ, mᵢ) is the decryption algorithm of a downloader (Pⱼ) with input of g^{r}^{_{i,j}} and its private key, by dividing mᵢg^{r}^{_{i,j}}^{s}^{ⱼ} with (g^{r}^{_{i,j}})^{s}^{ⱼ} to get plain piece mᵢ.

6. T(Pⱼ, Pₖ, mᵢ) is a re-encryption function that transforms a ciphertext of mᵢ encrypted by the public key and TS key of Pⱼ into a ciphertext of mᵢ encrypted by the public key and TS key of Pₖ. Upon receiving cipher piece mᵢg^{r}^{_{i,k}}^{s}^{ⱼ}, Pⱼ encrypts it with input g^{(r}^{_{i,k}}^{s}^{ₖ}^{-r}^{_{i,j}}^{s}^{ⱼ}⁾ from the tracker site, and outputs mᵢg^{(r}^{_{i,k}}^{s}^{ₖ}^{-r}^{_{i,j}}^{s}^{ⱼ}⁾=mᵢg^{r}^{_{i,k}}^{s}^{ₖ}.

It should be noted that, as explained in the performance evaluation section below, because the secure BT system is defined as an asymmetric system, with selective encryption, only a portion of the being distributed objects needs to be encrypted.

In short, for each torrent, the tracker site generates system-wide parameters through SGen before making the downloading service available. When a peer joins the torrent to download a file, it first subscribes to the tracker site. Upon a successful subscription, a peer performs PGen to generate its private key and sends the public key to the tracker site. The tracker site generates a set of random numbers as TS keys for this peer, each for one file piece.

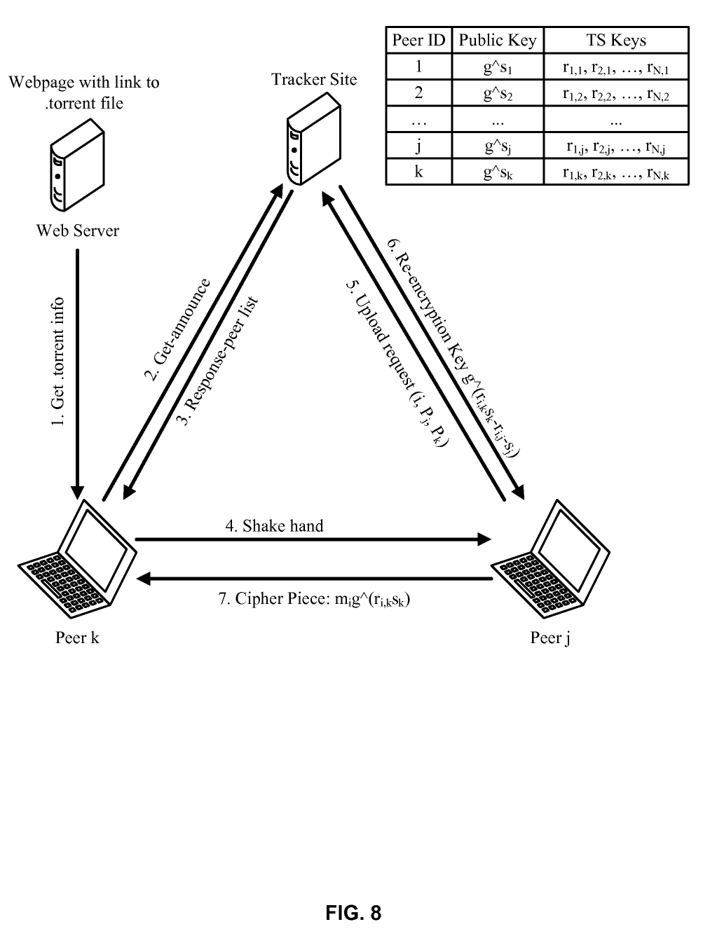

As an embodiment, FIG. 8 represents the enhanced scheme with an example of data transmissions between two general peers, as stated in Algorithm 2 below. In the enhanced scheme, only the original seed (Pₒ) has all plain pieces. Each peer needs to subscribe to the tracker site before starting to download file pieces. Upon the subscription, in which the subscription and optional authentication service can be conducted by the tracker site or a trusted party, a peer generates a pair of private key and public key with PGen. The private key is kept secretly while the public key gets registered with the tracker site. Note that for simplicity of illustration, a public key authentication mechanism is not included here. Existing approaches, such as PKI and SSL, can be used for this purpose when a peer subscribes to the tracker site. Corresponding to a peer's public key, the tracker site generates a set of TS keys with TGen, each for one piece of the file, and these keys are safely preserved by the tracker site. After a successful subscription, a peer (say Pⱼ, for instance) gets a list of active peers that have file pieces available in the system. In the initial step, pieces are only available from Pₒ. When Pₒ decides to upload a piece to Pⱼ, it encrypts the plain piece with Pⱼ's public key and the corresponding TS key from the tracker site (with PEnc) such that only Pⱼ can decrypt it. When Pⱼ decides to upload an encrypted piece to another peer (say Pₖ, for instance), it first re-encrypts the cipher piece with an input from the tracker site so that only Pₖ can decrypt it (with T). Pₖ can also upload this encrypted piece to other peers following the similar procedure. A downloader cannot decrypt received cipher pieces without the decryption keys (provided by the tracker site) included in a license file and enforced by a trusted player. By leveraging the function of the existing tracker site, the present invention does not need additional infrastructure support to distribute and certify public keys of peers.

At a high level, the present invention does not demand any additional infrastructure support from existing BT systems. But, the tracker site does assume more responsibility since there is a peer table maintained by the tracker site to store active peer ids, and corresponding public keys and TS keys.

II. Protocol Design of Secure BT System

A. Encryption Protocols

There are two working protocols for downloading copyrighted protected content in BT systems. The first is for the transmission between the original seed and a downloader, shown as Algorithm 1 in TABLE 1 below. The protocol works as follows. Initially, the original seed (Pₒ) has all plain pieces of the file. When Pⱼ joins the system, it gets the .torrent file from a public web server (message 1), contacts the tracker site (message 2), and gets a list of active peers (message 3). Suppose Pⱼ wants to download piece mⱼ from Pₒ after the “shake hand” step (message 4), Pₒ forwards the request to the tracker site (message 5). The tracker site computes the encryption key with the public key of Pⱼ and r_{i,j}, and sends it back to Pₒ (message 6). Pₒ uses PEnc(Pⱼ, mᵢ) to encrypt the piece with the received key from the tracker site and uploads it to Pⱼ (message 7).

The second algorithm (Algorithm 2) is for data transmission between two normal peers, as indicated in FIG. 8 and TABLE 1. After the first four normal steps (message 1-4), before Pⱼ uploads cipher piece mⱼ to Pₖ, Pⱼ first forwards the request to the tracker site (message 5). The tracker site computes the re-encryption key, which is the division between the public key of Pₖ with r_{i, k} and the public key of Pⱼ with r_{i, j}, and sends the division to Pⱼ (message 6). Pⱼ uses T(Pⱼ, Pₖ, mᵢ) to transform the cipher piece with the re-encryption key received from the tracker site and sends the result to Pₖ (message 7).

TABLE 1
Encryption algorithms in data transmission

| | Algorithm 1 | Algorithm 2 |
|---|---|---|
| 1 | WS → Pⱼ: Get.torrent file | WS → Pₖ: Get.torrent file |
| 2 | Pⱼ → TS: Get announce | Pₖ → TS: Get announce |
| 3 | TS → Pⱼ: Response peer list | TS → Pₖ: Response peer list |
| 4 | Pⱼ → Pₒ: Shake hand | Pₖ → Pⱼ: Shake hand |
| 5 | Pₒ → TS: UploadRequest(i, Pₒ, Pⱼ) | Pⱼ → TS: |
| | | UploadRequest(i, Pⱼ, Pₖ) |
| 6 | TS → Pₒ: (g^{s}^{ⱼ})^{r}^{_{i,j}} = g^{r}^{_{i,j}}^{s}^{ⱼ} | TS → Pⱼ: (g^{s}^{ₖ})^{r}^{_{i,k}}/(g^{s}^{ⱼ})^{r}^{_{i,j}} = |
| | | g^{r}^{_{i,k}}^{s}^{ₖ}^{-r}^{_{i,j}}^{s}^{ⱼ} |
| 7 | Pₒ → Pⱼ: mᵢg^{r}^{_{i,j}}^{s}^{ⱼ} | Pⱼ → Pₖ: mᵢg^{r}^{_{i,j}}^{s}^{ⱼ} g^{r}^{_{i,k}}^{s}^{ₖ}^{-r}^{_{i,j}}^{s}^{ⱼ} = |
| | | mᵢg^{r}^{_{i,k}}^{s}^{ₖ} |

B. Decryption Protocol

To decrypt the received cipher piece of mᵢ, Pₖ needs g^{r}^{_{i,k}}, which is provided by the tracker site. To prevent a peer from sharing plain pieces during downloading, decryption keys are only included in the license file for each user. In particular, after downloading all cipher pieces of an object and before playing that object, the player of a peer contacts a license server and gets a license file. Without loss of generality, the license server is assumed to be the same as the tracker site. (As a side note, in practice, if the license server is different from the tracker site, the tracker site only needs to send the TS keys of a user to the license server to generate the license file upon the request.) The license server generates the decryption keys of all pieces and sends the license file to the user. The decryption process is illustrated as Algorithm 3, as shown in TABLE 2.

TABLE 2
Decryption algorithm in data transmission

| | Algorithm 3 |
|---|---|
| 8 | Pₖ → TS (or license server): GetLicense(Pₖ) |
| 9 | TS → Pₖ: g^{r}^{_{i,k}} for 1 ≦ i ≦ N, these keys are included in a license |
| | file. |
| 10 | Pₖ: mᵢg^{r}^{_{i,k}}^{s}^{ₖ}/(g^{r}^{_{i,k}})^{s}^{ₖ} = mᵢ for 1 ≦ i ≦ N. |

As indicated by the steps in TABLE 2, Pₖ contacts the tracker site (or the license server) be sending a GetLicense message (message 8). The tracker site generates decryption keys of all pieces, includes them in a license file, and sends back to Pₖ (message 9). Usage policies are specified in the license file according to related information (e.g., user's payment). When playing the content, the trusted player of Pₖ uses PDec to decrypt cipher pieces with the received keys and its private key. The player enforces the usage policies specified in the license file (message 10).

Note that TS keys are generated by the tracker site upon the subscription of a peer. Thus, the decryption keys and the license file can be issued by the license server independently from the content downloading in the present invention. The capability of uploading unique cipher pieces to other peers without decryption enables the enhanced scheme to seamlessly work with existing BT systems for efficient content distribution. This feature is enabled by the re-encryption algorithm and centralized TS key management. At a high level, the present invention adds a centralized security architecture above the decentralized content distribution infrastructure of BT systems.

The present invention is supported and can be enabled via the following theorem. Let ε_{bt}=(SGen, PGen, TGen, PEnc, PDec, T) be a secure BT Content Distribution System. The problem of recovering a plain piece mᵢ from (g^{s}^{ⱼ}, g^{s}^{ₖ}, . . . , mᵢg^{r}^{_{i,j}}^{s}^{ⱼ}, mᵢg^{r}^{_{i,k}}^{s}^{ₖ}, . . . , g^{r}^{_{i,k}}^{s}^{ₖ}^{-r}^{_{i,j}}^{s}^{ⱼ}, . . . , g^{r}^{_{i,j}}, g^{r}^{_{r,k}}, . . . ) is at least as hard as Diffie-Hellman.

Proof Sketch For simplicity, messages may be transmitted by uploading mᵢ from Pⱼ to Pₖ. Due to the unidirectional flow of a single piece in a BT system, mᵢ is not uploaded from Pₖ to Pⱼ. Therefore, messages that are publicly available to an adversary are (g^{s}^{ⱼ}, g^{s}^{ₖ}, mᵢg^{r}^{_{i,j}}^{s}^{ⱼ}, mᵢg^{r}^{_{i,k}}^{s}^{ₖ}, g^{r}^{_{i,k}}^{s}^{ₖ}^{-r}^{_{i,j}}^{s}^{ⱼ}, g^{r}^{_{i,j}}, g^{r}^{_{i,k}}).

First, g^{(r}^{_{i,k}}^{s}^{ₖ}^{-r}^{_{i,j}}^{s}^{ⱼ}⁾ can be derived by (mᵢg^{r}^{_{i,k}}^{s}^{ₖ})/(mᵢg^{r}^{_{i,j}}^{s}^{ⱼ}) so that it is redundant for cryptanalysis. To find mᵢ, either g^{r}^{_{i,j}}^{s}^{ⱼ} or g^{r}^{_{i,k}}^{s}^{ₖ} must be derived. With the knowledge of g^{s}^{ⱼ} and g^{r}^{_{i,j}}, the problem to find g^{r}^{_{i,j}}^{s}^{ⱼ} is exactly the Diffie-Hellman problem. The same holds for finding g^{r}^{_{i,k}}^{s}^{ₖ}. This proves that ε_{bt} is at least as secure as Diffie-Hellman. It should be noted that as the typical piece size in a BT system is 256 KB, the present invention does not consider attacks on the plain El Gamal encryption, where a much smaller message size is used.

III. Integrity Verification and Vulnerability

After a peer finishes downloading and obtains all cipher pieces, the integrity of each piece can be checked by the player, using the decryption keys included in the license file and the hash values in the torrent file. Instead of the instant integrity verification in original BT systems, the player-performed verification is largely due to the fact that file pieces that a peer downloads are encrypted and the decryption is not possible without a trusted player and the decryption keys in a license file. From the viewpoint of efficiency, this does not increase the overhead of the system, since a corrupted piece can be found and re-downloaded, no matter when it is detected. Optionally, a client can check the integrity of received pieces anytime during downloading, since the license file can be issued separately from the content distribution. For example, it can be issued right after the subscription of a peer.

If a client does not perform any integrity check during downloading, the present invention opens a door for content pollution. Alternatively, a slight extension of the enhanced scheme can prevent this type of attack. Suppose the tracker site has a copy of all plain pieces. Upon the subscription of a peer (say Pₖ, for instance), the tracker site knows its public key (g^{s}^{ₖ}) and generates its TS keys (r_{1, k}, . . . , r_{N, k}). Then, the tracker site can compute all expected hash values of the cipher pieces that the peer will download, e.g., H(mᵢg^{r}^{_{i,k}}^{s}^{ₖ}) for mᵢ, where H is a hash function. The tracker site sends these hash values to the peer upon its subscription. During the downloading process, the piece integrity verification can be performed with the same way as that in original BT systems. Since the tracker site can compute the hash values for a peer offline when the peer subscribes the service, runtime performance overhead can be avoided.

However, as the tracker site is the central server for storing TS keys and generating re-encryption keys, it has the single point failure problem. Fundamentally, this type of attack exists in the original BT system since the tracker site maintains an active peer list in the system, which can be compromised and results in denial of service (DoS) attacks. While trackerless BT protocols have been proposed, they generally address only part of this problem.

IV. Alternative Designs

Given that in the enhanced scheme, each peer and each piece are allocated a TS key, some may wonder whether it is sufficient if only a single TS key (for all pieces in a torrent) is allocated to a peer or only a single TS key (for all peers in a torrent) is allocated to a piece. Addressing this concern, the following alternative designs to the enhanced scheme are presented below. However, although these alternatives are simpler, they are flawed in general environments and may only work under certain conditions.

A. Alternative Scheme 1

For a peer, its TS keys are identical for all pieces, i.e., r_{i,k}=r_{i′,k}=rₖ for any i≠i′. However, the problem of this scheme is that piece m_{i′} can be derived with mᵢ and the encrypted form of m_{i′}. For example, an adversary intercepts message 7 of TABLE 1 and obtains cᵢ=mᵢg^{r}^{ₖ}^{s}^{ₖ} and c_{i′}=m_{i′}g^{r}^{ₖ}^{s}^{ₖ}, then cᵢ/c_{i′}=mᵢ/m_{i′}. That is, all cipher pieces are linkable, and a known single plain piece can infer all other pieces. Thus, this alternative scheme only works when all players and license files are always well protected.

B. Alternative Scheme 2

For a piece, the TS keys are identical for all peers, i.e., r_{i,j}=_{i,k}=rᵢ. This alternative scheme cannot prevent peer collusion. Specifically, since the decryption keys of Pⱼ and Pₖ are the same, they can share a single license file and get the same permission with only one payment. Also, a malicious peer can publish a license so that everyone can use it. Such action would break the copyright protection mechanism.

C. Alternative Scheme 3

Each piece has a random number rᵢ, and the re-encryption key of Pⱼ for mᵢ is a function of rᵢ and g^{s}^{ⱼ}, e.g., (g^{s}^{ⱼ})^{r}^{ᵢ}=g^{r}^{ᵢ}^{s}^{ⱼ}. In this alternative scheme, collusion between Pⱼ and Pₖ can let Pₖ obtain its TS key, i.e., (g^{r}^{ᵢ}^{s}^{ⱼ})^{s}^{ₖ}^{/s}^{ⱼ}=g^{r}^{ᵢ}^{s}^{ₖ}. Thus, a single license file can be used by all collusive peers to play different copies they download.

V. Performance Evaluation

The enhanced scheme requires no additional changes to the original architecture of BT systems. But, peers and tracker sites need to perform additional operations, including data transmission, encryption, and transformation, for copyright protection. The following measures the overhead of these operations in order to verify the feasibility of the enhanced scheme based on an implemented prototype system. Particularly, the performance of BT systems with and without the newly enhanced scheme is compared.

A. Encryption/Decryption Overhead Measurement

The performance overhead is mainly due to the additional security functions. To study the overhead, the enhanced scheme was implemented in BitTorrent v.4.0.1. The performance overhead was evaluated for a general peer and a tracker site. Both the peer and the tracker site are on machines of Pentium 4 CPU 3.4 GHz with 1 GB memory, running Red Hat Linux 9 with gcc 3.2.2. The performance was studied with the Botan crypto library 1.6.1, which implements the El Gamal algorithms (key generation, encryption, and decryption).

TABLE 3 shows the measured transaction time (seconds) for system parameter generation (SGen), piece encryption (PEnc) and decryption (PDec), re-encryption key generation on the tracker site (Tracker), and cipher piece transformation by a peer (T), respectively. These experiments were run repeatedly 10 times with the module size, n (the number of bits of the encryption key), varying from 512 bits to 2048 bits.

TABLE 3
Performance overhead (in seconds)

| Key size (bits) | SGen (s) | PEnc (s) | PDec (s) | Tracker (s) | T (s) |
|---|---|---|---|---|---|
| 512 | 0.029 | 5.526 | 8.862 | 0.0516 | 0.029 |
| 768 | 0.047 | 7.993 | 10.931 | 0.105 | 0.037 |
| 1024 | 0.081 | 10.657 | 12.350 | 0.251 | 0.043 |
| 1536 | 0.195 | 16.995 | 17.473 | 0.371 | 0.055 |
| 2048 | 0.381 | 22.985 | 21.763 | 0.442 | 0.062 |

It is a reasonable conjecture that the system parameter generation and exponential operations are the main overhead sources in the enhanced security scheme. As shown in the SGen column, the parameter generation with a larger key size takes a longer time. However, even with a key size of 1024 bits, the key generation is still very fast. Note that this generation is a one-time operation for each torrent.

The PEnc and PDec columns show the time for encrypting and decrypting a single file piece of 256 KB. According to the protocols proposed above, for each piece, the encryption is only performed by the original seed. Thus, this overhead does not cause running performance degradation of other peers. On the other hand, for a general peer, the decryption is performed after the peer completes downloading the entire file. So this decryption does not affect the downloading performance. However, the encryption speed affects the performance of the original seed to upload encrypted pieces, and decryption speed is about 256 KB/12.350≈20 KB/s≈160 Kbit/s, which is slower than the required playback rate (encoding rate) of some Internet videos. However, this is less likely to be an issue in practice since options may be taken to improve performance.

For media objects, such as videos, the encryption of an entire object is commonly unnecessary. Instead, many selective encryption schemes have bee proposed and well studied. That is, instead of encrypting the whole object, only some critical data, such as I-blocks and relevant micro-blocks for MPEG videos, in the media file are encrypted. For an Internet MP4 (MEPG 4) file, its metadata are critical for constructing the scenes during the playback. That is, the player must use the metadata information to access the right raw data during the playback. If the metadata are encrypted, the playback cannot continue. In a media object, the total size of metadata is generally much smaller than the raw data, thus encrypting and decrypting the metadata may take much shorter time than those shown in TABLE 3. Typically, selective encryption can increase the overhead by as low as 9%. A similar idea can be applied to non-media files with a partial encryption scheme. Such application is also on the line of using an asymmetric key system to encrypt a very small amount of important data, making the enhanced scheme practical.

Furthermore, for encryption on the original seed side, the tracker can pre-generate encryption keys and send to it before downloading requests are received. The peers who download pieces from the original seed are predictable since the tracker replies a list of peers to a new peer and does have the public key of a possible requesting peer. With this pre-generated encryption key, the original seed can extensively accelerate the encryption speed. This relies on El Gamal's property that the exponentiations in encryption are independent of the message and can be computed ahead of time. Actually, the tracker can determine which peers can download from the original seed and generate all encryption keys with pre-processing.

The tracker site overhead is caused by the TS key generation (TGen) and maintenance. As a set of TS keys is assigned to a peer upon its subscription, this assignment can be pre-processed by the tracker site. That is, the tracker site can generate TS key sets in advance and assign one set to a peer upon its subscription. Thus, TS key generation can be performed without causing running performance overhead to the system.

During the procedure of content distribution, the tracker site also needs to generate re-encryption keys for uploading peers. The Tracker column shows the average time to generate a re-encryption key on the tracker site. For example, with a key size of 1024 bits, it takes about 0.25 seconds to generate a re-encryption key. For BT systems with a high request rate, this could be a performance bottleneck. Fortunately, the re-encryption key generation can also be pre-processed before the real data transmission, similar to that of the original seed. Particularly, after a peer obtains a list of active peers form the tracker site (message 3 from above), by predicting the possible transmissions between this peer and the active peers on the list, the tracker site can generate partial or all possible re-encryption keys in advance.

In addition to the computing overhead, a tracker site needs to maintain TS keys of all active peers, which introduces runtime space overhead. This overhead is closely associated with the number of active peers in a torrent, which is comparably small. For example, from a review of a workload for software distribution (RedHat 9) through BT, the number of active peers in every 8 hours is about 150, although there were 180,000 clients joining the torrent during 5 months (from April 2003 to August 2003). For an object of 1 GB, there are about 4,000 pieces with a piece size of 256 KB. If a key size of 1024 bits is used in the enhanced scheme, the total space overhead for key storage is 150×4000×1024/8=75 MB. This overhead is acceptable with a modern machine.

As indicated in TABLE 1, in the enhanced scheme, there is extra overhead to the uploading peer for transforming cipher pieces and this transformation has to be conducted online. During the transformation, the new cipher piece is obtained by multiplying the re-encryption key received from the tracker site. As this is a multiplication operation, it is expected to introduce trivial overhead. The T column in TABLE 3 shows this overhead with a piece size of 256 KB. The resulting transformation overhead is trivial.

B. Communication Overhead Measurement on PlanetLab

In addition to the overhead caused by security related operations that have been evaluated, there is also addition communication overhead in the enhanced scheme. For example, for each piece being downloaded, the uploading peer needs to get a re-encryption key form the tracker site. Since each peer only connects to a limited number of other peers, this communication overhead is trivial and would not result in significant performance degradation.

However, for the tracker site, since it is the central point in the system, the present invention implements a prototype system, as experimented on PlanetLab. In the experiments, 4 dedicated seeds are set up with an uploading speed of 200 KB/s. Randomly selected 120 PlanetLab nodes are used as downloaders, from Asia, Europe, and United States. The object is a 640-MB file. Both the seeds and the tracker site are running on dedicated machines of Celeron CPU 2.4 GHz with 1 GB memory, and Linux Fedora 2.6.9 and Python 2.3.4.

The communication overhead on the tracker site would increase with the increasing number of concurrent downloading peers. But, there are a limited number of accessible nodes on current PlanetLab. As not many peers can be leveraged at the same time (e.g., 1000 peers), the file piece size was changed. With a fixed total size of a file, different piece sizes result in different numbers of file pieces. As the tracker site has to be involved for each piece downloading, decreasing the piece size can increase the communication overhead on the tracker site. Thus, if a regular piece size is 512 KB with 120 downloaders (which served as a baseline in the experiments), when the piece size is 32 KB, it is equivalent to increase 16 times communication load on the tracker site. That amount is equivalent to having 1,920 concurrent downloading peers.

In the experiments, all peer downloading was started almost simultaneously (within one minute) such that all peers are active during the experimental period. Each experiment was run with varying file piece sizes for one hour. At the end of the hour, all peers are downloaders. Therefore, the communication load on the tracker site is close to the peak.

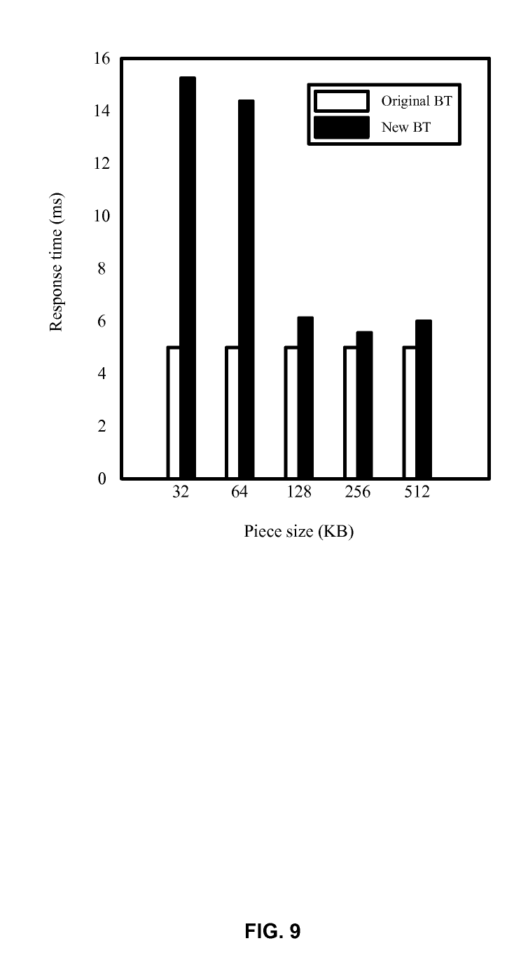

FIG. 9 shows the average message response time of the tracker site for a single downloading request. It is not surprising that in all cases the response time of the tracker site with the original BT system is close to each other, since a peer only contacts the tracker site for the peer list and reports its status. The response time difference between the new enhanced scheme and the original one decreases as the piece size increases, due to the decreasing load on the tracker site with a larger file piece size from 32 KB to 512 KB. With a piece size of 128 KB and 120 concurrent downloaders (equivalent to 480 concurrent downloading peers with a piece size of 512 KB) or higher, the average response time is slightly increased. Even when the piece size is 32 KB (equivalent to 1,920 concurrent downloading peers), the average message response time is still less than 16 ms averaged over 25,000 measured values within one hour. Because of the traffic variance along time in PlanetLab, the average response times with a piece size above 256 KB are slightly different in the enhanced scheme.

Thus, when the concurrent active peers are at a few hundred, which is the case according to L. Guo et al. and M. Izal et al., the security cost in the enhanced scheme does not really affect the response time to client requests and the system scalability.

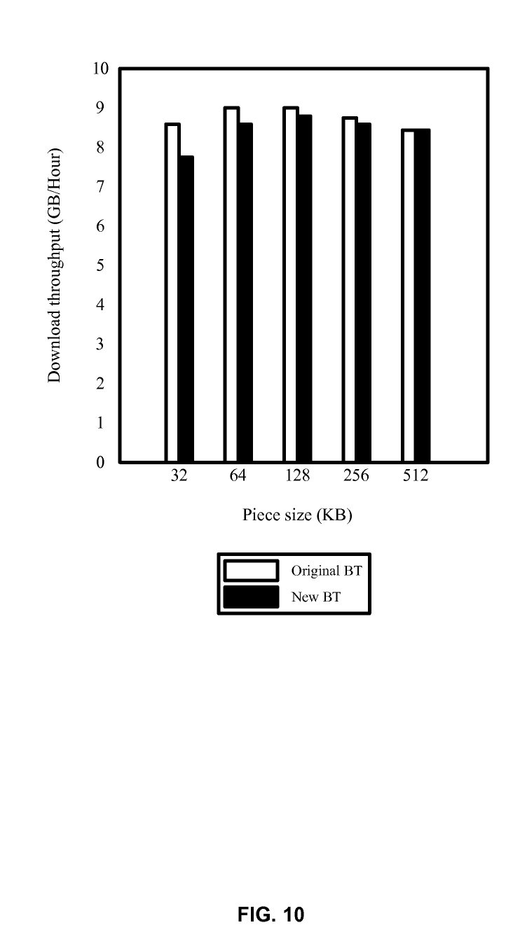

To evaluate how much the delayed response time affects the system throughput, particularly when the file piece size is small, the entire system throughput is also evaluated after the system has run for one hour. FIG. 10 shows the system throughput comparisons of the enhanced scheme with the original BT scheme. The result shows that the difference of the system throughput decreases as the piece size increases. Even with a 32 KB file piece, the difference between the system throughput is less than 10%. It is believed that such throughput degradation is acceptable for most practical systems and would not affect the system scalability. Again, the system throughput with the original BT protocol is slightly changing with varying file piece sizes because of uncontrollable network traffic variances in PlanetLab.

Overall, the emergence of BT systems on the Internet has attracted significant attention. Plenty of research and practice has shown and demonstrated its good scalability and efficiency for large file distribution. However, to date, it has not been leveraged to distribute the majority of copyrighted digital content over the Internet.

The present invention provides for a security mechanism based on the existing BT infrastructure to enable copyright protection. To evaluate this strategy, a prototype system was implemented and real experiments were conducted in PlanetLab. The evaluation results show that the enhanced scheme can achieve comparable content distribution efficiency to the original BT system. That is, to enable the copyright protection in such P2P systems, the enhanced scheme causes less than 10% degradation of the system throughput.

VI. Related Work

Many studies have been performed on the measurement and modeling on BT systems. In 2004, M. Izal et al. analyzed a five-month workload of a single BT system for RedHat source distribution and concluded that the BT system is scalable upon flash crowds. To investigate the feasibility of BT systems for data distribution, A. Bellissimo et al studied BT traffic of thousands of torrents over a four-month period. Meanwhile, J. Pouwelse et al. studied an eight-month BT workload and found that the arrival, aborting, and departing processes of downloaders do not follow the Poisson distribution, which were assumed in previous modeling work, such as that of D. Qiu and R. Srikant. This modeling work used a simple fluid model to characterize the overall performance of BT systems. It verified the scalability of BT systems and analyzed the effectiveness of BT incentive mechanism based on game theory. The study by X. Yang and G. Veciana shows an analysis of service capacity of BT systems and found that multipart downloading helps P2P systems to improve the performance during flash crowd period. L. Guo et al. found that BT systems have service stability and availability problems after flash crowds. R. Bindal et al. studied the impact of neighbor selection on the traffic locality in BT systems, while M. Piatek et al. analyzed the effectiveness of the incentive mechanism used in BT.

In terms of security mechanisms, several proxy re-encryption schemes and applications have been proposed. M. Blaze et al. proposed atomic proxy cryptography in which a proxy can divert a ciphertext of Alice to Bob with a delegated key. Improving this scheme, A. Ivan and Y. Dodis used unidirectional proxy re-encryption. Proxy re-encryption schemes based on El Gamal algorithm have been extensively studied by G. Ateniese et al. A similar scheme based on multi-key RSA has been proposed by S. Yeung et al. for video systems.

An implied assumption in most of these schemes is that the proxy is trusted or semi-trusted by the server. However, there are at least two major differences between the present invention and such schemes. First, unlike these schemes, a peer in the present invention is both a client and proxy in BT systems. Thus the peer cannot be trusted to have any re-encryption keys (i.e., TS keys) due to possible collusion between peers. In fact, even Y. Wu and F. Bao have pointed out that collusion attacks may occur between the proxy and general clients for the video-proxy scheme. Second, since each peer in the BT system can be a proxy to distribute content, the present invention's enhanced scheme eliminates the performance bottleneck that is often seen in the proxy-based schemes, where the re-encrypting operation is performed in a central proxy.

The foregoing descriptions of the embodiments of the present invention have been presented for purposes of illustration and description. They are not intended to be exhaustive or be limiting to the precise forms disclosed, and obviously many modifications and variations are possible in light of the above teaching. The illustrated embodiments were chosen and described in order to best explain the principles of the present invention and its practical application to thereby enable others skilled in the art to best utilize it in various embodiments and with various modifications as are suited to the particular use contemplated without departing from the spirit and scope of the present invention. In fact, after reading the above description, it will be apparent to one skilled in the relevant art(s) how to implement the present invention in alternative embodiments. Thus, the present invention should not be limited by any of the above described example embodiments. Rather, the present invention can also apply to nonmedical situations, such as strategic planning, housing development, insurance and other policy decisions, etc.

In addition, it should be understood that any figures, graphs, tables, examples, etc., which highlight the functionality and advantages of the present invention, are presented for example purposes only. The architecture of the disclosed is sufficiently flexible and configurable, such that it may be utilized in ways other than that shown. For example, the steps listed in any flowchart may be reordered or only optionally used in some embodiments.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the present invention of the application. The Abstract is not intended to be limiting as to the scope of the present invention in any way.

Furthermore, it is the applicants' intent that only claims that include the express language “means for” or “step for” be interpreted under 35 U.S.C. § 112, paragraph 6. Claims that do not expressly include the phrase “means for” or “step for” are not to be interpreted under 35 U.S.C. § 112, paragraph 6.

A portion of the present invention of this patent document contains material which is subject to copyright protection. The copyright owner has no objection to the facsimile reproduction by anyone of the patent document or the patent invention, as it appears in the Patent and Trademark Office patent file or records, but otherwise reserves all copyright rights whatsoever.

### REFERENCES

A. Bellissimo et al., Exploring the Use of Bittorrent as the Basis for a Large Trace Repository, TECH. REP. 04-41, U. MASS., AMHERST (2004).
J. Pouwelse et al., The Bittorrent P2P File-Sharing System: Measurements and Analysis, PROC. 4^{TH} INT'L WORKSHOP PEER-TO-PEER SYS. (IPTPS'05) (2005).
D. Qiu and R. Srikant, Modeling and Performance Analysis of Bittorent-like Peer-to-Peer Networks, PROC. ACM SIGCOMM (2004).
K. Skevik et al., Analysis of Bittorrent and its Use for the Design of a P2P Based Streaming Protocol for a Hybrid CDN, TECH. REP., DEPT. INFORMATICS, U. OSLO (2004).
X. Yang and G. Veciana, Service Capacity of Peer to Peer Networks, PROC. IEEE INFOCOM (2004).
A. Parker, The True Picture of Peer-to-Peer Filesharing, CACHELOGIC RES. (2004).
Study of File Formats Traversing the Peer-to-Peer Networks, CACHELOGIC RES. (2005).
B. Cohen, Incentives Build Robustness in Bittorrent, PROC. 1^{ST} WORKSHOP ECON. PEER-TO-PEER SYS. (2003).
L. Guo et al., Measurements, Analysis and Modeling of Bittorrent-Like Systems, PROC. ACM SIGCOMM INTERNET MEASUREMENT CONF. (2005).
T. Karagiannis et al., Is P2P Dying or Just Hiding, PROC. GLOBECOM (Dallas, Tex.), 2004.
Supreme Court Rules Against File Swapping, CNET NEWS.COM (Jun. 27, 2005).
Fairplay, WIKIPEDIA, at http://en.wikipedia.org/wiki/FairPlay.
Microsoft's Digital Rights Management Scheme-Technical Details, CRYPTOME (October 2001), available at http://cryptome.info/ms-drm.htm.
Windows Media Digital Rights Management (DRM), Microsoft, at http://microsoft.com/windows/windowsmedia/forpros/drm/default.mspx (last visited Jan. 7, 2009).
T. ElGamal, A Public Key Cryptosystem and Signature Scheme Based on the Discrete Logarithm, IT-31 IEEE TRANSACTIONS INFO. THEORY 469-472 (1985).
HANDBOOK OF APPLIED CRYPTOGRAPHY (A. J. Menezes et al., eds. 1996).
D. Boneh et al., Why Textbook ElGamal and RSA Encryption are Insecure, PROC. 6^{TH} INT'L CONF. THEORY AND APPL'N CRYPTOLOGY AND INFO. SEC.: ADV. CRYPTOLOGY (ASIACRYPT, 2000), 1976 LECTURE NOTES COMP. SCI. 30-43 (2000).
J. Liang et al., Pollution in P2P File Sharing Systems, PROC. IEEE REFORM (2005).
Bittorrent, at http://www.bittorrent.com.
Botan Crypto Library, at http://botan.randombit.net.
J. Wen et al., A Formal Complaint Configurable Encryption Framework for Access Control of Video, 12 IEEE TRANSACTIONS CIR. SYS. VIDEO TECH. 545-557 (2002).
M. Izal et al., Dissecting Bittorrent: Five Months in a Torrent's Lifetime, PROC. 5^{TH} PASSIVE ACTIVE MEASUREMENT WORKSHOP (Antibes, Juan-les-Pins, Fr.), 3015 LECTURE NOTES COMP. SCI. 1-11 (2004).
R. Bindal et al., Improving Traffic Locality in Bittorrent Via Biased Neighbor Selection, PROC. 26^{TH} INT'L CONF. DISTRIB. COMPUTING SYS. (ICDCS) (Lisboa, Port.), July 2006.
M Piatek et al., Do Incentives Build Robustness in Bittorrent?, PROC. 4^{TH} USENIX SYMP. NETWORKED SYS. DESIGN & IMPLEMENTATION (NSDI) (Cambridge, Mass.), April 2007.
M. Blaze et al., Divertible Protocols and Atomic Proxy Cryptography, PROC. EUROCRYPT '98 (Helsinki, Fin.), 1403 LECTURE NOTES COMP. SCI. 127 (1998).
A. Ivan and Y. Dodis, Proxy Cryptography Revisited, PROC. 10^{TH} ANN. NETWORK AND DISTRIB. SYS. SEC. SYMP. (NDSS) (San Diego, Calif.), February 2003.
G. Ateniese et al., Improved Proxy Re-Encryption Schemes with Applications to Secure Distributed Storage, PROC. 12^{TH} ANN. NETWORK AND DISTRIB. SYS. SEC. SYMP. (NDSS) (San Diego, Calif.), February 2005.
S. Yeung et al., A Case for a Multi-Key Secure Video Proxy: Theory, Design, and Implementation, PROC. ACM CONF. MULTIMEDIA (2002).
Y. Wu and F. Bao, Collusion Attack on a Multi-Key Secure Video Proxy Scheme, PROC. 12^{TH} ANN. ACM INT'L CONF. MULTIMEDIA (2004).

What is claimed is:

1. A method for enhancing BitTorrent-like peer-to-peer systems comprising:
a. generating system-wide parameters before making a downloading service available;
b. requiring a first peer to subscribe to a tracker site after the first peer joins a torrent;
c. generating a private key and a corresponding public key for the first peer after successful subscription;
d. registering the public key with the tracker site, wherein the tracker site uses the public key to generate a set of random numbers as tracker site (TS) keys for each piece of a file;
e. acquiring a list of active peers having available file pieces for the first peer;
f. having a seed peer upload at least one of the available file pieces for the first peer after the first peer shakes hand with the seed peer by encrypting the at least one of the available file pieces using the first peer's public key and the TS keys, creating a cipher piece;
g. allowing the first peer to download the cipher piece;
h. wherein if a second peer requests the cipher piece from the first peer, the first peer forwards the request to the tracker site;
i. having the tracker site compute a re-encryption key; and
j. re-encrypting the cipher piece using the re-encryption key, creating a re-encrypted piece.

2. The method according to claim 1, further including using the TS keys and the first peer's private key to decrypt the downloaded cipher piece.

3. The method according to claim 1, wherein the re-encryption key is a quotient of a public key of the second peer divided by the first peer's public key.

4. The method according to claim 3, wherein the second peer's public key is generated, along with a corresponding private key, after the second peer successfully subscribes to the tracker site.

5. The method according to claim 1, further including forwarding the re-encrypted piece to the second peer.

6. The method according to claim 5, further including having the second peer sending a license request to the tracker site.

7. The method according to claim 6, wherein upon receipt of the license request, the tracker site generates decryption keys for the re-encrypted piece.

8. The method according to claim 7, wherein the tracker site further includes the decryption keys in a license and sends both to the second peer.

9. The method according to claim 8, further including allowing the second peer to play the re-encrypted piece on a trusted player by decrypting the re-encrypted piece with the decryption keys and the second peer's private key.

10. A method for re-encrypting keys in BitTorrent-like peer-to-peer systems comprising:
a. prior to allowing a peer to make a request for at least one encrypted piece of a file, requiring the peer to subscribe to a tracker site after joining a torrent;
b. uploading the request to the tracker site after successful subscription;
c. having the tracker site compute a re-encryption key for the encrypted piece, wherein the re-encryption key is a quotient of a public key of a second peer divided by a public key of a first peer, and wherein the second peer is the requester of the encrypted piece and the first peer is the holder of the encrypted piece; and
d. using the re-encryption key to transform the encrypted piece into a re-encrypted piece.

11. The method according to claim 10, wherein upon successful subscription to the tracker site, both the second peer's public key and the second peer's private key, and the first peer's public key and the first peer's private key, are generated.

12. The method according to claim 11, further including having the second peer sending a license request to the tracker site.

13. The method according to claim 12, wherein upon receipt of the license request, the tracker site generates decryption keys for the re-encrypted piece.

14. The method according to claim 13, wherein the tracker site further includes the decryption keys in a license and sends both to the second peer.

15. The method according to claim 14, further including allowing the second peer to download the re-encrypted piece from the first peer and play the re-encrypted piece on a trusted player by decrypting the re-encrypted piece with the decryption keys and the second peer's private key.

16. A digital rights protection system that enhances BitTorrent-like peer-to-peer systems comprising:
a. a system-wide parameter generator configured for generating at least two system-wide parameters;
b. a peer-key generator configured for generating, for each peer, a random number as a private key and a corresponding public key for the private key, when the peer subscribes to a tracker site;
c. a tracker site key generator configured for using the public key to generate a set of random numbers as tracker site (TS) keys for each piece of a file; and
d. the tracker site configured for:
i. creating a cipher piece by using the public key and the TS keys to encrypt at least one available file piece by;
ii. generating at least one re-encryption key; and
iii. generating decryption keys upon receipt of a license request.

17. The digital rights protection system according to claim 16, further including a subscription verifier configured for verifying successful subscription to the tracker site and thereafter sending a signal to the peer-key generator to commence generation of the private key and the corresponding public key.

18. The digital rights protection system according to claim 16, wherein the number of the random numbers equal the number of pieces of the file.

19. The digital rights protection system according to claim 16, wherein the public key is registered with the tracker site.

20. The digital rights protection system according to claim 16, wherein the re-encryption key re-encrypts the cipher piece into a re-encrypted piece.
